(19) United States
(12) Patent Application Publication
(10) Pub. No.: US 2013/0151950 A1
(43) Pub. Date: Jun. 13, 2013

(54) SYSTEM AND METHOD FOR WEB PRESENCE FOR ONE OR MORE GEOGRAPHICAL LOCATIONS

(71) Applicant: PHOTOPON, INC., Hackettstown, NJ (US)

(72) Inventors: Bradford Alexander McEvilly, Newton, NJ (US); Michael Scott Gutkin, Denville, NJ (US)

(73) Assignee: PHOTOPON, INC., Hackettstown, NJ (US)

(21) Appl. No.: 13/774,857

(22) Filed: Feb. 22, 2013

Related U.S. Application Data
(63) Continuation-in-part of application No. 13/667,678, filed on Nov. 2, 2012.
(60) Provisional application No. 61/601,847, filed on Feb. 22, 2012.
(60) Provisional application No. 61/554,634, filed on Nov. 2, 2011.

(51) Int. Cl. G06F 17/24

(52) U.S. Cl. CPC G06F 17/24
USPC 715/234

(57) ABSTRACT

System and method to provide a discovery-augmented web presence for one or more geographical locations. Embodiments may provide open access to geographical location-based web presence content, allowing the presence content to be created by users based on location verification and user anti-spam qualification. Embodiments enable a legitimate location owner or representative to claim and manage at least a portion of the user-created presence content, thus providing improved transparency and accuracy in location-related content.

### CROSS-REFERENCE TO RELATED APPLICATIONS

This application claims the benefit of U.S. Provisional Patent Application Ser. No. 61/601,847, filed on Feb. 22, 2012, the entire content of which is hereby incorporated by reference in its entirety. This application also is a continuation-in-part of U.S. patent application Ser. No. 13/667,678, filed on Nov. 2, 2012, which in turn claims the benefit of U.S. Provisional Patent Application Ser. No. 61/554,634, filed on Nov. 2, 2011, the content of both of which are hereby incorporated by reference in their entirety.

### BACKGROUND

1. Field of the Invention

Embodiments of the present invention generally relate to web presence, and, in particular, to a system and method for customizable web presence based upon geographic location of a client browser.

2. Description of Related Art

People spend significant time consuming information on their handheld computing devices while they are traveling and visiting different geographical locations. Businesses are missing out on the opportunity this presents to engage with their visiting customers through their mobile phones during these occurrences in a centralized, streamlined, fast, efficient, and effective way. Instead they spend more time and resources trying to engage with these customers through social pages, inefficient location-based web presences, and similar location-based and non-location-based social media at various points in time. They are then left to try to accurately figure out what these same consumers are spending and how loyal they really are. There is no explicit way of determining their return on investment (“ROI”) on social pages and the other mentioned media efforts because when the social page user leaves the social web page, the user is not tracked in a centralized, streamlined, accurate, efficient, and effective way as the user visits one of the social page owner's various physical locations and interacts with business representatives, make various on-site purchases, etc.

In addition, consumers need access to information that is more relevant to the geographical locations they are visiting. Many times only the location owners can provide the relevant information, or the information can only be provided by some combination of the location owners and location community.

Furthermore, policy or information may differ among different geographical locations belonging to the same organization. The existing global public networking/web infrastructure approach may fail to effectively accommodate these differences at some scales. For example, individual franchise owners may be questioned about their participation regarding a coupon or sales event sponsored by a franchisor or other franchisee. This is currently difficult to communicate to loyal or new customers.

Existing systems do not allow for multiple geographical locations to receive shared elements of a customized web presence. This can become cumbersome for larger organizations with multiple locations that wish to offer the same or similar presence content wherein “content” is intended to refer to web-based information, products, services, or any combination thereof. This makes it equally difficult for communities of various geographical locations to manage their own presences and content.

Existing systems do not allow for public and/or community-generated and managed geographical location-based web presences and related content.

Existing systems do not allow for default presence creation for verified geographical locations.

Existing systems assume that geographical location's presence creator is also the location owner, and therefore hinder rapid proliferation of geographical location-based web presences and prevents unbiased content and transparency also known as a unified location voice as provided through a presence created by either the location's owner, visitors, or both.

Therefore, a need exists to provide a more customizable web presence to customers or potential customers based upon their geographic location, in order to provide more targeted and specific information to users, gain valuable real-time insight on performance metrics at different locations, and ultimately improved customer satisfaction and improved sales.

### SUMMARY

The invention provides the option for open access to the described geographical location-based web presence content, allows such content to be created by anyone based on location verification and user anti-spam qualification algorithms. Open access may include an ability for an anonymous user (i.e., a user who has not provided identification or login credentials) to receive substantially any information available to users. However, a terminal (e.g., a smartphone) of an anonymous user may still be tracked by way of an identifier such as an IP address, or a range of IP addresses that the terminal is a member of, or geographic location derived from the user's terminal. In some embodiments, an anonymous user may be able to provide or upload a predetermined category of information, whereas a user who has logged in may be able to provide or upload a larger category or more numerous categories of information. Relevant information may be determined at least in part by proximity of the user to a physical location of a business corresponding to the domain owner.

Embodiments enable a legitimate location owner or representative to claim and manage some or all of a community-generated presence, leaving the option for transparency and accuracy in location-related content. This is specific to chosen invention implementation. A legitimate location owner may be known as a rightful business owner or property owner of the physical location, as opposed to a cyber squatter or spoofer.

Embodiments in accordance with the present invention provide improved geographical location-based information, products, and services to be created by both the location owners and non-owners alike. Owners that create or claim geographical location-based web information, products and services may or may not be able to assume control over what web page information, products, and services the community created for the geographical location.

Furthermore, embodiments provide a system and method for rating informational accuracy. A piece of content or information, created by one user for the available presence, may be rated by later users.

Embodiments in accordance with the present invention may allow a presence administrator to designate one or more geographic locations for rapid presence syndication (i.e., updates) and context or “instance” assignment.

Embodiments in accordance with the present invention allow an owner of a web presence operating in multiple geographical locations to share a foundational web presence, from which an instance of the web presence is generated that may then be customized with information and/or context specific to a geographic location. Providing instances of a web presence in this way enables providing geographical location-based web presence and related data management and modification without affecting the web presence instances at other geographic locations. Embodiments provide an efficient system and method to change either a specific web presence instance, or to change a foundational web presence for a group of related web presences. In some embodiments, the foundational web presence is used as a template from which other geographic-specific web presences are derived. A set of geographic-specific web presences may be stored, and when a user requests to view or interact with the web presence of the location owner, one of the stored web presences may be selected and presented to the user based upon the user's geographic location. Alternatively, when a user requests to view or interact with the web presence of the location owner, the user's geographic location may be determined and a web presence is dynamically generated based upon the user's geographic location. Dynamic generation may provide more fine-grained control of how the user's geographic location affects the web presence the user sees. The user may interact with the web presence (e.g., by posting comments, requesting support, etc.), and whether the interactions are made publicly accessible and/or their public content is under control of the owner of the web presence, and in particular under the control of the owner of the geographically nearest or most geographically-specific web presence.

Some embodiments may provide a hierarchy of web presence foundations. For example, a global company (e.g., auto maker) might have a single, world-wide web presence foundation. Building on that, the auto maker might have a series of nation-specific web presence foundations that might describe products offered in the respective nations. A nation-specific web presence would not be available to all web users world-wide. Instead, a web user's geographic location would be determined, and a web foundation specific to the nation in which the web user is located would be provided to the web user.

Next level down may be (in the U.S.) state-level or marketing-region level web presences (e.g., “your tri-state Ford dealers”). A marketing-region level web presence would be available only to web users who are physically within the marketing-region. The web user's geographic location would be determined, and a web foundation specific to the marketing region in which the web user is located would be provided to the web user. If a web user is in a geographic location that is not within a marketing region (or is otherwise not within a defined geographic domain of the present level of the hierarchy), a web foundation of a higher level of the hierarchy may be supplied to the web user.

Embodiments in accordance with the present invention may allow for one web presence (e.g., one member of a hierarchy) to be used as a template, starting point or the like for one or more other web presences (e.g., one or more members of a different level of the hierarchy), such that the web presences are customized for the geographic location of a user viewing the web presence. Levels of the hierarchy have different owners. The user would then interact with the most geographically-specific web presence owner.

Next level down, to an actual instance, may be a web presence instance for an individual auto dealer. An auto dealer web presence would be available only to web users who are physically within the sales region of the specific auto dealer. The web user's geographic location would be determined, and a web foundation specific to the sales region in which the web user is located would be provided to the web user. Physical distance from the web user to an auto dealer may be used instead to determine which web presence instance to server to the web user. Alternatively, a user may be shown a listing of all dealers within a predetermined distance from the user, and the user given an opportunity to select from among the available auto dealers.

In some situations (e.g., for certain types of business), a hierarchy may be carried down even further to a web presence instance for individual sales agents, for example a web presence for an individual Coldwell Banker real estate agent. Selection of an individual agent whose web presence instance is provided to a web user may be based on geographic location of the web user and sales territories of the sales agents. If sales territories overlap, then secondary considerations gleaned from the social presence of the web user and/or sales agents may be used to select a preferred match.

By combining a physical location with a web site in such a way that harnesses the benefits of both, embodiments of the invention provide an infrastructure for a more effective and efficient modern marketplace for consumers and businesses.

To accomplish the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

Embodiments in accordance with the present invention provide a system and method to provide customizable web content, the method including: receiving an access request from a user for a predetermined entity; receiving an identity of a geographic location of the user; selecting a web presence for the entity, wherein the web presence corresponds to the geographic location of the user; customizing the web presence to produce a customized web content; and providing the customized web content to the user.

Embodiments in accordance with the present invention provide a system to provide customizable web content, the system including: a web server; a presence server that is communicatively coupled to the web server; a user interface module configured to receive an access request from a user for a predetermined entity; a position-determination module configured to receive an identity of a geographic location of the user; and a processor coupled to a memory, wherein the processor is configured to perform the steps of: communicating the geographic location to the presence server; receiving one or more presences from the presence server for the entity, wherein the web presence corresponds to the geographic location of the user; and customizing the web presence to produce a customized web content, wherein the web server is configured to provide the customized web content to the user.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a system in accordance with an embodiment of the present invention;

FIG. 2 illustrates at a high level of abstraction a process to access presence information, in accordance with an embodiment of the present invention;

FIG. 3 illustrates at a relatively lower level of abstraction a process of presence access and registration, in accordance with an embodiment of the present invention;

FIG. 4A illustrates at a high level of abstraction a process of Presence registration and control via API user, in accordance with an embodiment of the present invention;

FIG. 4B illustrates at a lower level of abstraction a process of Presence registration and control via non-API user, in accordance with an embodiment of the present invention;

FIG. 5 illustrates an initial user interface for presence list control and registration, in accordance with an embodiment of the present invention;

FIG. 6 illustrates a more populated user interface for presence list control and registration, in accordance with an embodiment of the present invention; and

FIG. 7 illustrates a menu tree of a user interface in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in substantially any communication application in which it is desirable to utilize web presence.

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some contexts, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein, the term “location owner” refers generally to an entity associated with a physical location. For example, a location owner may be a domain name owner or web entity owner or a trademark owner. For example, if a user is at a shopping mall, and more particularly if the user is within a store at the shopping mall, the location owner associated with the user's geographic location may be the domain name owner of the store in which the user is physically located. In another example, suppose that company “A” owns restaurants that operate under names “B” and “C”. A diner at restaurant “B” may see the owner of a geographically-specific presence of “B” as the most geographically-specific location owner, but the owner of a geographically-specific presence of “A” may also be viewed as a location owner. If the user is at a shopping mall but not in a particular store (e.g., in an atrium or food court), the location owner may be a domain name owner associated with the shopping mall itself.

As used herein, the term “location community” refers generally to a set of users who repeatedly visit, use or patronize a particular location.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

As used herein, the terms “business” or “businesses” are not limited to for-profit commercial establishments. Unless clearly indicated explicitly or by the surrounding context, businesses may include substantially any entity that interacts either uni-directionally or bi-directionally with members of the public. This will include for-profit commercial establishments of any structure (e.g., incorporated, LLC, partnership, sole proprietor, etc.), non-profit groups, charities, educational institutions, religious institutions, governmental bodies, associations (e.g., VFW, chamber of commerce, etc.), and so forth.

As used herein, the term “instance” refers to a clone or copy of a foundational website (i.e., an initial or parent web presence whose components will be useful at all locations). For a distinct location having an associated instance, custom components and data may be added that do not affect instances at other locations. Businesses may then be left to try to accurately figure out spending habits of these same consumers and how loyal are the customers.

As used herein, the term “web presence instance” refers to a clone of the web presence and related content that may or may not share a same database or database elements. Database and database elements may refer to database table structure, field names, field type, existing data, table types (e.g., one-to-many, many-to-many, etc.) and so forth, which may be needed to serve the intended web presence. A web presence instance may be used to provide a similar web presence at multiple locations in such a way that allows for the subsequent modification to the web presence and its content without affecting the web presence itself or substantially any other generated web presence instances available at various geographical locations. A web presence instance may also be available at a single or multiple locations, and functions substantially the same as a “web presence.” Therefore, the term “web presence instance” may be used interchangeably herein when referring to a “web presence.”

People often spend significant time consuming information on their handheld computing devices while they are traveling and visiting different geographical locations. Businesses may miss out on opportunities this presents to engage with customers or potential customers (generically, “customers”). In particular, businesses miss an opportunity to engage with customers through their customers' mobile phones as the customers visit different geographical locations. Engagement through mobile technology would offer a centralized, streamlined, fast, efficient, and effective way to engage. Instead, businesses spend more time and resources than necessary trying to engage with these mobile customers through social pages, inefficient or unfocussed location-based web presences, and similar location-based and non-location-based social media at various moments.

Businesses have no explicit way of determining their return on investment (“ROI”) on social pages and the other mentioned media efforts because there is no known way to track sales results at physical stores and link the sales to social media interactions in a centralized, streamlined, accurate, efficient, and effective manner. For example, when a social page user leaves a social web page and physically visits a physical location of the business associated with the social web page (i.e., a “bricks and mortar store”), and is interacting with representatives of that business (e.g., making on-site purchases, and other quantifiable consumer actions), such interaction is not tracked in a centralized, streamlined, accurate, efficient, and effective way.

In addition, consumers often need access to information that is relevant to their present geographical location. For example, a consumer may be visiting from out of town, and needs information (e.g., for shopping, restaurants, gas stations, emergency services, etc.) that many times only the location owners can provide or that can only be provided by some combination of the location owners and location community.

Furthermore, specific organizational issues may exist relating to differences in the validity or relevancy of information among different geographical locations belonging to the same organization. The existing global public inter networking/web infrastructure approach fails to effectively accommodate these differences across geographic regions. For example, individual franchise owners are often questioned about their participation regarding a coupon or sales event sponsored by a franchisor or competitor franchisee. Such differences among franchisees across different geographic regions are currently difficult to communicate to loyal or new customers. Embodiments in accordance with the present invention provide a system and method to deliver information that is valid and relevant to the consumer's geographic location, in order to more efficiently augment their physical experience.

Embodiments in accordance with the present invention mitigate these problems by providing a centralized, streamlined, effective, and efficient web presence for one or more geographical locations, such that the web presence is customized and easily accessible to a visitor based on the visitor's location. In some embodiments, the customization may also take into account related factors such as a location of the business that is nearest to the customer, or the proximity of the customer to the business. In some embodiments, the web presence may be associated with a category of businesses (e.g., restaurants, or restaurants at Times Square, etc.) or with the location itself (e.g., a landmark, a national park, traffic jam alerts along a particular highway, map-based listing of selected categories of establishments, etc). Embodiments may provide these benefits to a visitor automatically and without requiring in advance that the visitor be registered to receive these benefits.

Embodiments in accordance with the present invention also provide discovery augmentation, which acts to combine a physical location with a web location. Discovery augmentation provides a hybrid type of website that augments (i.e., adds to) a physical discovery or learning experience at a physical location. Embodiments facilitate entire websites to be developed for a specific location but in such a way that a visiting world wide web user can use a starting template to expedite and make the process easier for subsequent web sites, like a factory stamping metaphorical widgets. Businesses at the physical locations may need their own websites to be customized to the geographic surroundings, just as much as the businesses need signage décor for the same location. Embodiments provide mobile sites for a mobile era. A template may be used to save global content that is common to all users of the template, then the template is cloned (i.e., a copy is created for customization) such that the information in the clone may be separately managed.

A web presence in accordance with an embodiment of the present invention may contain content relative to the geographical location and/or its nearby surroundings. Content may be customizable to an individual user or user type based on the user's location, the nearest location of the owner of the web presence, and/or the distance between the user and the owner of the web presence. Such content of the web presence content may include substantially any type of information and/or products and/or services commonly available through similar web sites such as privately owned and/or community-driven information and services. For example, a particular web presence may provide ecommerce service content to users that visit a geographical location and access the location's relatively unique geographical location-based web presence or other services like social media services, tourism and traveler information, and so forth.

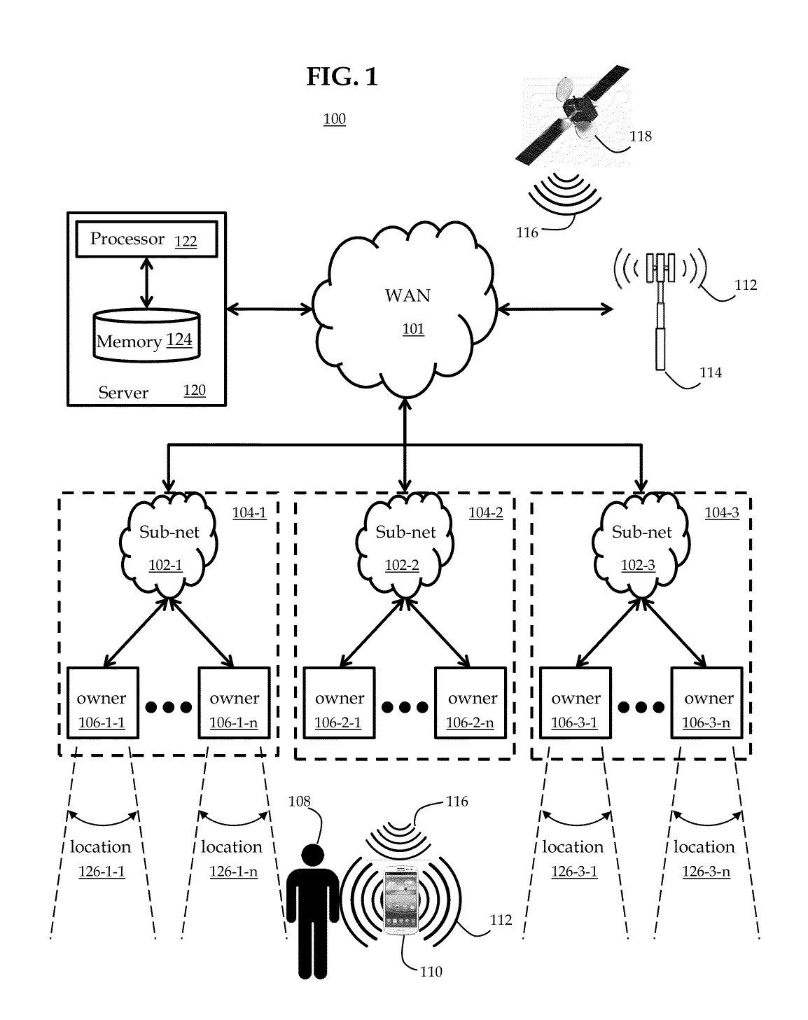

FIG. 1 illustrates at a high level of abstraction a system 100, in accordance with an embodiment of the invention. For sake of clarity, FIG. 1 may include illustration of some external items which are not part of system 100, but rather are designed to interface with system 100. For example, some elements of system 100 may be interconnected directly or indirectly by wide area network (“WAN”) 101, but system 100 does not necessarily include WAN 101 itself. Instead, system 100 may include appropriate receivers, transmitters, transceivers, routers, hubs, gateways, firewalls, etc. (not explicitly illustrated in FIG. 1) as known in the art in order to communicate via WAN 101.

Some embodiments in accordance with the present invention may include a hierarchical approach to owners of a geographic location. This hierarchical approach is illustrated in FIG. 1 by use of optional domains 104-1, 104-2 and 104-3 (generically referred to herein as domains 104). One or more of domains 104 may be further subdivided into smaller sub-domains (not illustrated in FIG. 1), and so forth. Domains 104 may include a respective sub-network 102-1, 102-2 and 102-3 (generically, sub-networks 102) in order to communicatively interconnect elements within the respective domain 104. System 100 does not necessarily include Sub-networks 102 themselves. System 100 may include appropriate receivers, transmitters, transceivers, routers, hubs, gateways, firewalls, etc. (not explicitly illustrated in FIG. 1) as known in the art in order to communicate via sub-network 102.

System 100 may include one or more locations owners 106. A specific “nth” location owner 106 located in domain “m” may be referred to herein as location owner 106-m-n. Associated with a location owner 106 is a respective location 126 (or location 126-m-n). Location 126 refers to physical locations that are sufficiently physically near to the respective location owner 106, as illustrated in FIG. 1. For sake of clarity, locations 126-2-n are not illustrated in FIG. 1. The remainder of FIG. 1 illustrates logical, communicative, and/or associative relationships between elements of system 100 rather than physical relationships.

System 100 is usable by user 108, who may have access to or use a communication device 110. Communication device 110 may include a smartphone, tablet PC, laptop PC, desktop PC such as may be located at an Internet café, and so forth. Communication device 110 is communicatively coupled directly or indirectly to WAN 101. In the embodiment of FIG. 1, communication device 110 may be communicatively coupled via radio waves 112 to cell phone tower 114, which in turn is communicatively coupled to WAN 101.

Other embodiments in accordance with the present invention (not illustrated in FIG. 1) may include direct communication via a peer-to-peer or ad hoc network or the like, linking communication device 110 and presence owner 106-m-n. The physical layer may use short-range communication technology such as near-field communication (“NFC”), Bluetooth (IEEE 802.15.1), Zigbee (IEEE 802.15.4), and so forth. Such direct communication may later be posted, by presence owner 106-m-n, to the associated web presence.

Returning to FIG. 1, Communication device 110 may further include a position-determination module that is able to determine the current geographic location of communication device 110. For example, communication device 110 may use radio signals 116 from a GPS system 118 in order to determine its location. Alternatively, the position-determination module may accept a user-defined position (e.g., as referenced by an address, zip code, landmark (e.g., “JFK airport”, “downtown Chicago”, etc.), latitude/longitude coordinates, and so forth). A user-defined position may be useful when a user wants to receive information for a place different than their current location (e.g., at an arrival airport).

User 108, using communication device 110, may access a user interface on communication device 110, which in turn allows user 108 to use client software on communication device 110 to access the newly created presence content or presence instance content. User 108 may select from the available presence or presence instances from a geographical location-based list displayed by the user interface of communication device 110.

Once user 108 selects a presence or presence instance, in some embodiments in accordance with the present invention the location owner may interact with and/or collect user data provided by user 108. In some embodiments, data collection from user 108 may be controlled by a privacy setting that is controlled by user 108.

The location owner may edit the presence or presence instance at substantially any time. If a presence instance is modified then it will not necessarily affect other presence instances. If a presence is edited, the edits may be confined to the specific presence instance being edited, and not propagated to instances not generated from the said presence. For example, in a hierarchical model of web presences, changes to a parent web presence may propagate to corresponding changes in child web presences that depend upon the parent web presence.

In some embodiments in accordance with the present invention, certain components or foundational data may be automatically updated when a parent web presence (or controlling user) updates it. For example, an update process may start with a set of redundant presence “clones,” such that each clone presence may be updated per location based on user rights and/or privileges to make presence updates. By this method, per-location data may be maintained relevant and accurate without affecting other geographic locations which may or may not be participating in a franschisor's offer, or which may prefer different web site components altogether depending on which components best serve users at that location.

For example, suppose a first franchisee of a business is not located near a lake, and a second franchisee is located near a lake. A web presence for the first franchisee may include a trails component for listing trails around the first franchisee, whereas a web presence for the second franchisee may include a boat rental guide component for lakes near the second franchisee. In this example, both franchisees would have the same foundational data and component needs, but then their web presences branch off depending on individual franchisee circumstances. In some embodiments, updates of the foundational data itself may apply only to certain locations.

User 108 may select from an alias list of geographical locations, and associate a pre-existing web site as a presence or presence content for the selected geographical location. This association may be stored and made accessible for other, later users 108, or for an API user, and/or search engine spider (i.e., a crawler). An API user may be known as a third-party application that uses access to data of the business in order to provide a customized web presence. A non-API user may be a web user who is for other information.

Clients on more than one communication device 110 may be concurrently connected to the presences or presence instances available at location 126-m-n for real-time interaction. A client application on communication device 110 may also interact with clients that are connected to other locations 126, e.g., in order to comment on issues that are in common between the respective locations 126. The interaction may be by use of the architecture of FIG. 1, or by a direct communication technology (e.g., NFC). If no presence exists for a given location, the user may login and create a web presence instance using default or user-provided parameters, e.g., a core, generic restaurant template for a restaurant or a golf course template for a golf course, and so forth. The data transmitted may be stored in the system for later analysis, in order to improve services later, or to study demographic information and ROI from social site users. Tools and analysis may be facilitated by API functions provided by the social media site (e.g., Facebook).

System 100 may further include a server 120. Server 120 includes at least processor 122 and memory 124. Memory 124 may include tangible storage of computer instructions that, when executed by processor 122, perform at least portions of methods described herein. Server 120 services requests from communication device 110 in a client/server manner. In some embodiments in accordance with the present invention, server 120 is a presence server, which provides information to web servers that submit a request for presence. For example, owner 106-m-n may utilize a web server. The web server for owner 106-m-n provides the credentials of user 108 to presence server 120, and then presence server 120 provides customized information to the web server, which in turn is then sent to user 108 as part of the web presence instance. Server 120 may be maintained by an administrator for embodiments of the present invention, or alternatively the functions of server 120 may be provided as a cloud-computing service to users of embodiments in accordance with the present invention.

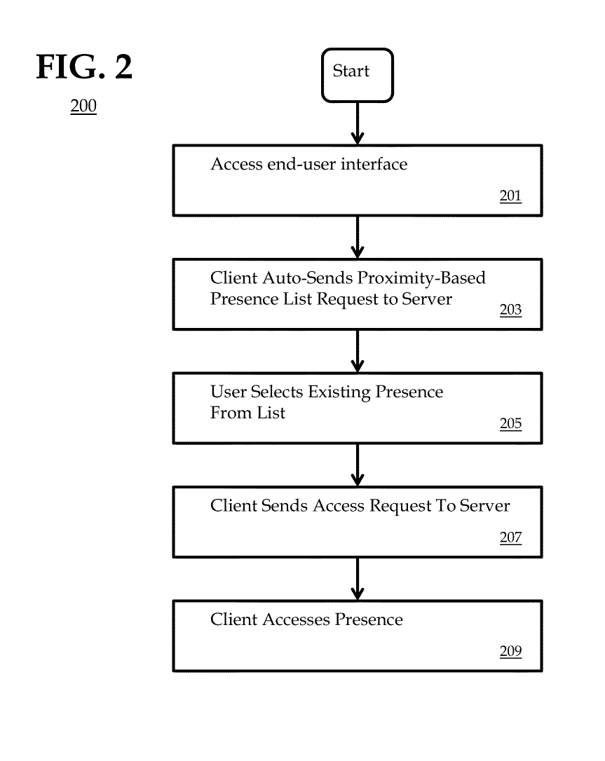

FIG. 2 illustrates at a high level of abstraction a process 200 of using system 100. Process 200 begins at step 201, at which a user (e.g., a user visiting from outside the local area) accesses their end-user interface, which is typically provided by communication device 110. The end-user interface may function as a presence control interface.

Process 200 then transitions to step 203, at which a client (e.g., communication device 110) sends a request to server 120 for proximity-based information. The requested information may include, e.g., a presence-based web page or list of web pages, wherein the content of the one or more presence-based web pages has been customized for the owner of the requested geographic location, which may be based upon the location of communication device 110, or based upon another geographic location provided by user 108. If the geographic location is based on the location of communication device 110, the location may be provided automatically (i.e., without involvement by user 108) and/or by default.

Embodiments in accordance with the present invention may generate the presence and/or presence instances for substantially any specified or existing content. Default content may also be associated with the presence. If multiple locations are provided, separate presence instances—one per location by default or one presence instance per multiple locations as specified—are generated and assigned accordingly. Embodiments may optionally use geographical location information provided internally or by a third-party source—that periodically updates such information—to generate default web presences for location alias, coordinate data, and so forth.

Embodiments in accordance with the present invention create a presence for the owner of a web presence for a specified geographic location by using a default presence template or, if provided with the presence parameters, a specified existing presence name, a presence template, an internal or external presence URL, or other presence content. Embodiments in accordance with the present invention may optionally use geographical location information provided locally or internally (e.g., by direct user input) or by a third-party source (e.g., GPS), provided that the geographical location is periodically updated, in order to generate default web presences for a location alias, coordinate data, or other available information.

Process 200 then transitions to step 205, at which user 108 may select from the available presences returned by step 203.

Process 200 then transitions to step 207, at which client communication device 110 transmits to server 120 an access request for the presence selected at step 205.

Process 200 then transitions to step 209, at which user 108 of communication device 110 is able to access the presence information supplied by server 120, which had been requested at step 207.

Usage of system 100 may be further illustrated at a different level of abstraction by direct reference to FIG. 1. For example, in operation of system 100, user 108 while using communication device 110 may enter into one of the plurality of locations 126. By use of the position-determination module in communication device 110, user 108 will know which location 126-m-n they are within. Thereafter, when an informational display such as that produced by a web server associated with owner 106-m-n is to be displayed on communication device 110, the web server transmits a request for customized information to server 120, and server 120 responds by transmitting the customized information to the web server, such that the web site provides code for a display that is rendered on communication device 110, the display being customized for the present location of communication device 110. If communication device 110 moves to a different location 126, a display customized for the new present location of communication device 110 will be rendered.

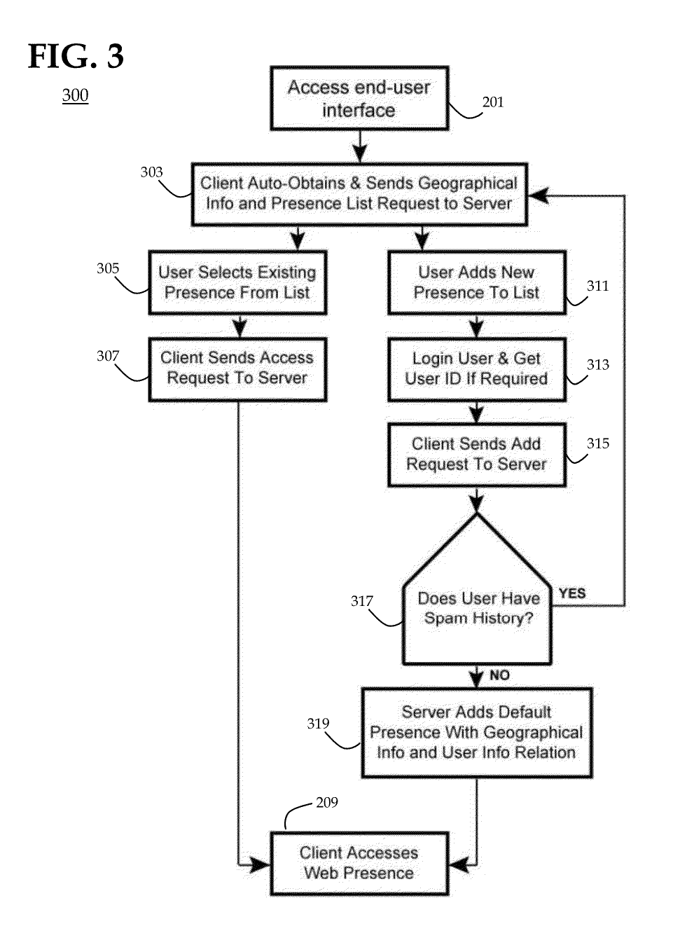

FIG. 3 illustrates at a lower level of abstraction a process 300 of using system 100. Process 300 begins at step 201, at which a user (e.g., a user visiting from outside the local area) accesses their end-user interface.

Control of process 300 next transitions to step 303, at which client software operating on communication device 110 obtains geographic location information of either communication device 110 itself or for a location specified by user 108, as described earlier. The client software includes this information into a request for presence information that is transmitted to server 120.

If the result of step 303 is that one or more presence instances already exists for the requested geographic location (i.e., from different entities such as fast food restaurant “A” and “B”) such that they are accommodative and unique to that location and contain information available only at that location, control of process 300 will transition to step 305, at which user 108 is presented a list of available presences and selects from among the list. However, if the desired presence is not on the list, control of process 300 may transition to step 311.

Following step 305, control of process 300 next transitions to step 307, at which the client software running on communication device 110 sends an information request to presence server 120. If a visitor adds a presence to a location that until then lacked a presence, the user can associate presence to a public web site domain for the location owner in order to act as presence until the location owner claims the site and creates a presence. In an embodiment, the user can create the presence for the owner to claim or not claim later on. In this implementation, the user can add relevant web information that will be listed within the web presence, including links to other social media and world wide web information relevant to the location (e.g., Foursquare tips and Foursquare pages for that location, links to Yelp profiles or pages for that location, links to world wide domain names in existence and owned by that location, user generated data non preexisting for that location, various imagery or itinerary for that location, and so forth).

Following step 307, control of process 300 next transitions to step 209, at which the client software running on communication device 110 is granted access to the web presences information for owner 106. Process 300 ends at the conclusion of step 209.

If the result of step 303 is that one of more presence instances for does not already exist for the requested geographic location 126-m-n, control of process 300 will transition to step 311, at which user 108 may add a new presence for owner 106-m-n at location 126-m-n to a list of presences known to server 120. An association is thereby created and stored, which associates the new presence to geographic location 126-m-n.

Following step 311, control of process 300 next transitions to step 313, at which user 108 may optionally provide login credentials (e.g., user name and password).

Following step 313, control of process 300 next transitions to step 315, at which the client software running on communication device 110 sends a request to server 120, requesting that presence information for the desired location 126 and/or owner 106.

Following step 315, control of process 300 next transitions to step 317, at which server 120 checks whether user 108 has a history of sending or submitting spam. The determination of a history may be based upon the number or frequency of spam postings, or percentage of overall postings that were classified as spam, or similar metrics, that exceed a predetermined threshold value. The history may weight recent activity differently (e.g., provide more weighting by use of a windowing function) than older activity. Spam activity may be tracked and stored in a separate component and/or in conjunction with third-party anti-spam service.

If the response to step 317 is positive, then user 108 is not allowed to proceed at this time, and control of process 300 transitions back, e.g., to step 303.

If the response to step 317 is negative, then following step 317, control of process 300 next transitions to step 319, at which server 120 adds customized information to the web page delivered to user 108. The customized information may include default presence information, geographic information, user information, and so forth.

Following step 319, control of process 300 next transitions to step 209, which is described above, and process 300 terminates.

A geographical location-based web presence may be created either by the corresponding location owner, qualified representative, or the location's visitors. If created by its visitors, it is referred to as a community-driven presence. In contrast, an owner-driven presence may include a web presence whose content is created or controlled at least in part by the business. The invention may offer a community-driven presence by default or in conjunction with an owner-driven presence and by may be generated using community-driven content. An example of a community-driven geographical location-based web presence is a location-specific history wiki page for visiting users to generate multiple media during their visit to a location. Such media may then be voted up or rated for relevancy, spam, obscenity, etc., by subsequent location presence visitors.

In addition, links to existing World Wide Web sites may be provided by location visitors or location owners for a geographical location-based web presence to further assist visitors by providing highly geographically-relevant information, products, and services.

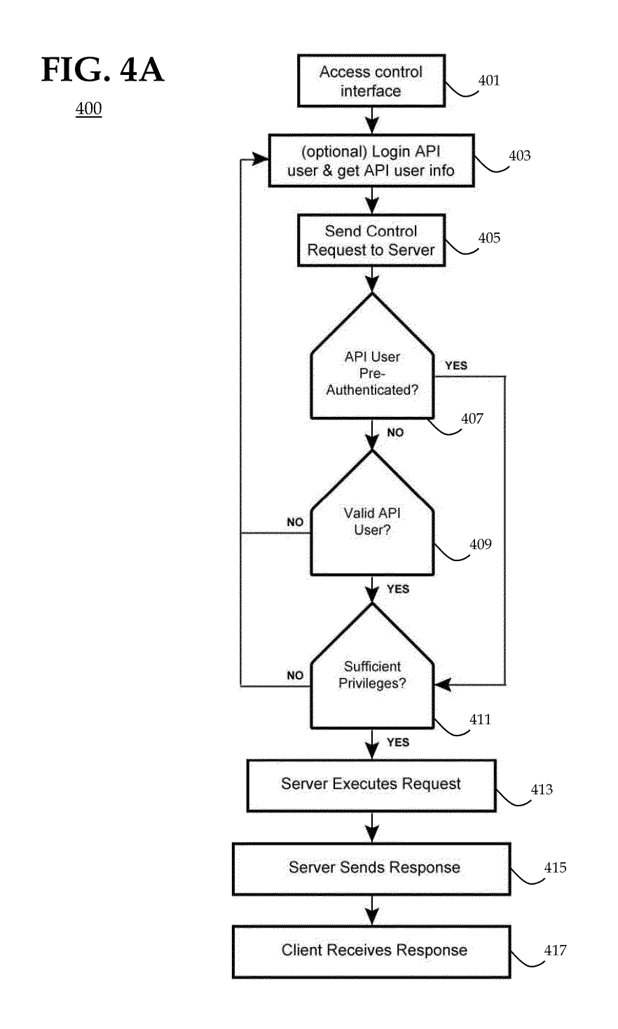

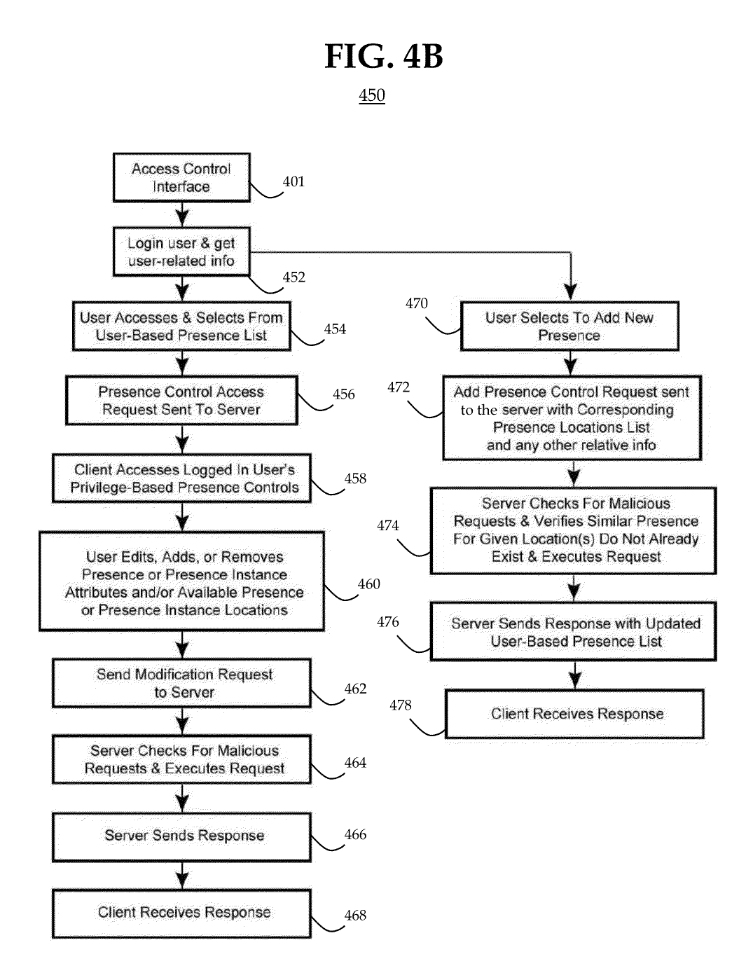

FIG. 4A illustrates at a high level of abstraction a process 400 for presence registration and control via API user, in accordance with an embodiment of the present invention. Process 400 begins at step 401, at which a user attempts to access a control interface on communication device 110. Next, at optional step 403, a login application program interface (“API”) may be used to provide an input/output interface to the user in order to provide a convenient interface for a user to enter login credentials and in some embodiments do a limited amount of error-checking.

Next, process 400 transitions to step 405, at which a control request, arising from a user action provided by the user, is sent to server 120.

Next, process 400 transitions to decision step 407, at which an inquiry is made into whether the API user has been pre-authenticated. If the answer at step 407 is “Yes,” then control of process 400 passes to decision step 411. If the answer at step 407 is “No,” then control of process 400 passes to decision step 409.

At decision step 409, at which an inquiry is made into whether the user is a valid API user, i.e., whether the credentials presented by the user are valid. If the credentials are not valid, then control of process 400 passes to step 403. If the answer at step 409 is “Yes,” then control of process 400 passes to decision step 411.

Next, process 400 transitions to decision step 411, at which an inquiry is made into whether the user possesses sufficient privileges. If the user does not have sufficient privileges, then control of process 400 passes to step 403. If the answer at step 411 is “Yes,” then control of process 400 passes to step 413.

At step 413, server 120 has received the response and acts upon the request.

Next, process 400 transitions to step 415, at which the response generated at step 413 is transmitted to the user.

Next, process 400 transitions to step 417, at which the user receives the response generated at step 413, and process 400 terminates.

FIG. 4B illustrates at a lower level of abstraction a process 450 for presence registration and control via non-API user, in accordance with an embodiment of the present invention. Process 450 (like process 400) begins at step 401, at which a user attempts to access a control interface on communication device 110.

Next, process 450 transitions to step 452, the user is able to log in, and the system is able to send to the user for display the available user-related information for the requested geographic location (which is ordinarily the location of communication terminal 110). If the information sought by the user has been returned, then control of process 450 transitions to step 454. If the information sought by the user has not been returned, then control of process 450 transitions to step 470.

At step 454, a list or menu of available information returned at step 452 is presented to the user, and the user is able to select from among the available information.

Next, control of process 450 transitions to step 456, at which a presence control access request generated by user 108 using communication terminal 110 is sent by client software to server 120.

Next, control of process 450 transitions to step 458, at which client software running on communication terminal 110 accesses the privilege-based presence controls of user 108. Privilege-based presence control may include permission to use administrative rights, group membership, root (e.g., super-user) membership, and so forth.

Next, control of process 450 transitions to step 460, at which user 108 is afforded an opportunity to edit, add, or remove presence information, presence instance attributes, and/or available presence or presence instance locations.

Next, control of process 450 transitions to step 462, at which the modifications requested by the user at step 460 are transmitted by the client software on communication terminal 110 to server 120.

Next, control of process 450 transitions to step 464, at which server 120 checks whether the request provided from step 462 is a malicious request or otherwise is erroneous (e.g., invalid syntax). If the request passes all checks, then server 120 executes the request from step 462.

Next, control of process 450 transitions to step 466, at which the response generated at step 464 is sent, by server 120, to the client software running on communication terminal 110.

Next, control of process 450 transitions to step 468, at which the client software running on communication terminal 110 receives the response sent by server 120 at step 466. Process 450 concludes at the end of step 468.

At step 470, if the result of step 452 was that the information sought by the user had not been returned at step 452, then user 108 is able to indicate through menu selection or the like that a new presence is to be added.

Next, control of process 450 transitions to step 472, at which user 108 is able to add the presence information. A control request that indicates the presence information is sent to server 120 along with a list of corresponding presence locations and other relevant information as required.

Next, control of process 450 transitions to step 474, at which server 120 checks whether the request provided from step 472 is a malicious request or otherwise is erroneous (e.g., invalid syntax). Server may also check whether the request is for redundant or duplicative information, i.e., whether the requested information for the specified location is substantially similar to information that is already available. If substantially similar information is already available, then that information is retried and supplied to user 108. If substantially similar information is not already available, and if the request passes all other checks, then server 120 executes the request from step 472.

Next, control of process 450 transitions to step 476, at which server 120 sends the response generated at step 474 to the client software running on communication terminal 110. The response will include an updated user-based presence list.

Next, control of process 450 transitions to step 478, at which the client software running on communication terminal 110 receives the response sent by server 120 at step 46. Process 450 concludes at the end of step 478.

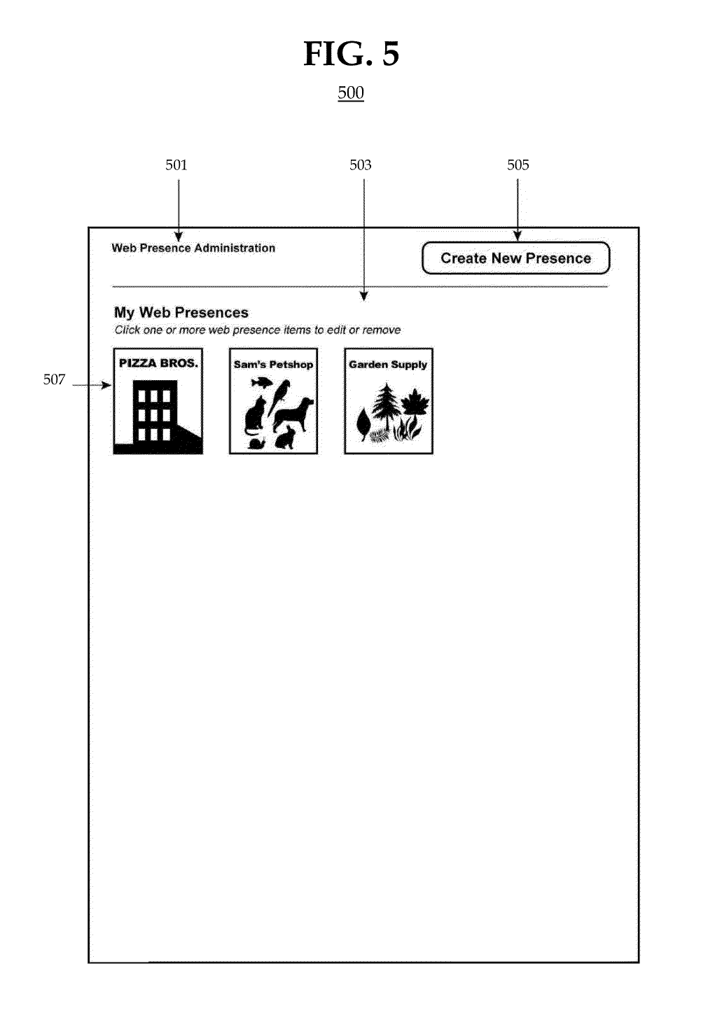

FIG. 5 illustrates an initial user interface 500 for presence list control and registration, in accordance with an embodiment of the present invention. In particular, user interface 500 depicts a user interface that is useful for web presence administration, as indicated by title field 501.

User interface 500 may include a section 503 that is useful for displaying selection controls (e.g., icons or the like) corresponding to available web presences that are available for user 108 to select. Control 507 depicts a representative control in the form of an icon. Selecting control 507 will load available web presence instances corresponding to the selected control 507. If the desired web presence is not listed in section 503, the user may create a new presence by activating control 505.

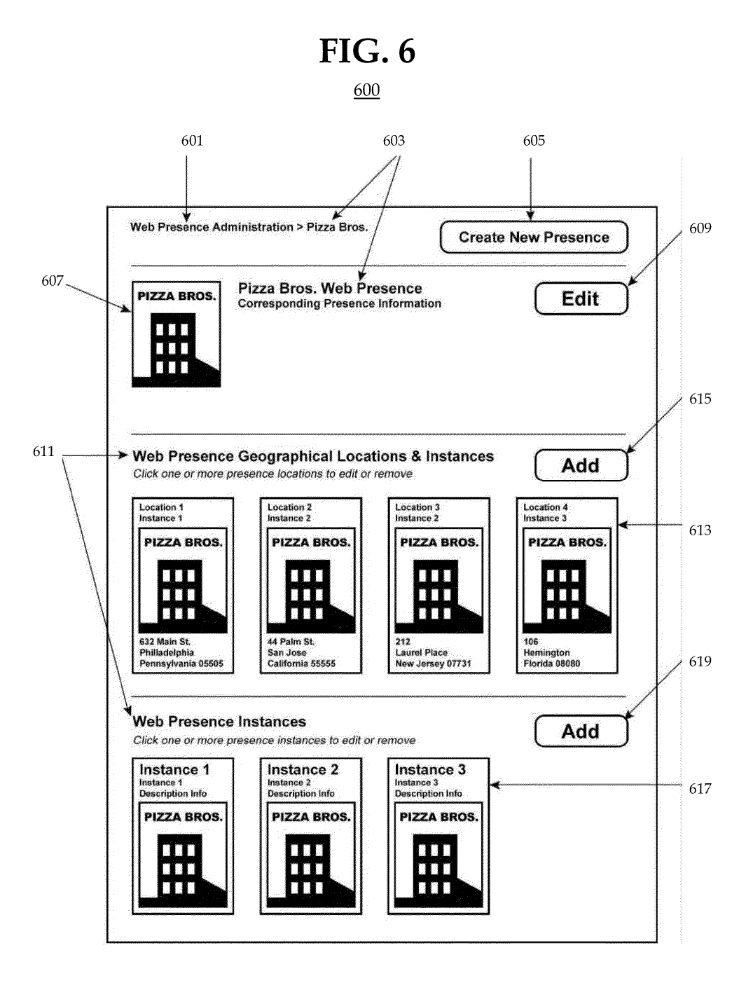

FIG. 6 illustrates a more populated user interface 600 for presence list control and registration, in accordance with an embodiment of the present invention. User interface 600 represents an interface that may be presented on communication terminal 110 after user 108 had selected control 507, as indicated by title field 601.

User interface 600 includes indicators 603 that indicate to user 108 that the corresponding sections of user interface 600 are referring to a particular web presence. Control 607 depicts the selected control in the form of an icon. Properties of control 607 may be edited by selecting control 609.

User interface 600 includes section 611. A first portion of section 611 may indicate web presence geographic locations and instances that are available for selection by user 108. Available web presence geographic locations and instances are indicated by one or more controls 613, which may be in the form of icons. Clicking on a control 613 in the first portion of section 611 may be used to view, edit or remove the respective web presence geographic locations or instances. If a desired web presence geographic location or instance is not available, control 615 may be used to manually add another web presence geographic location or instance. Even though “location 2” and “location 3” are widely separated, they may use the same web presence instance, i.e., “Instance 2.” Consequently, changes to location 2's web site will also be made to location 3's web site.

A second portion of section 611 may indicate web presence instances that are available for selection by user 108. Available web presence instances are indicated by one or more controls 617, which may be in the form of icons. Clicking on a control 617 in the second portion of section 611 may be used to view, edit or remove the respective web presence instance. If a desired web presence instance is not available, control 619 may be used to manually add another web presence instance.

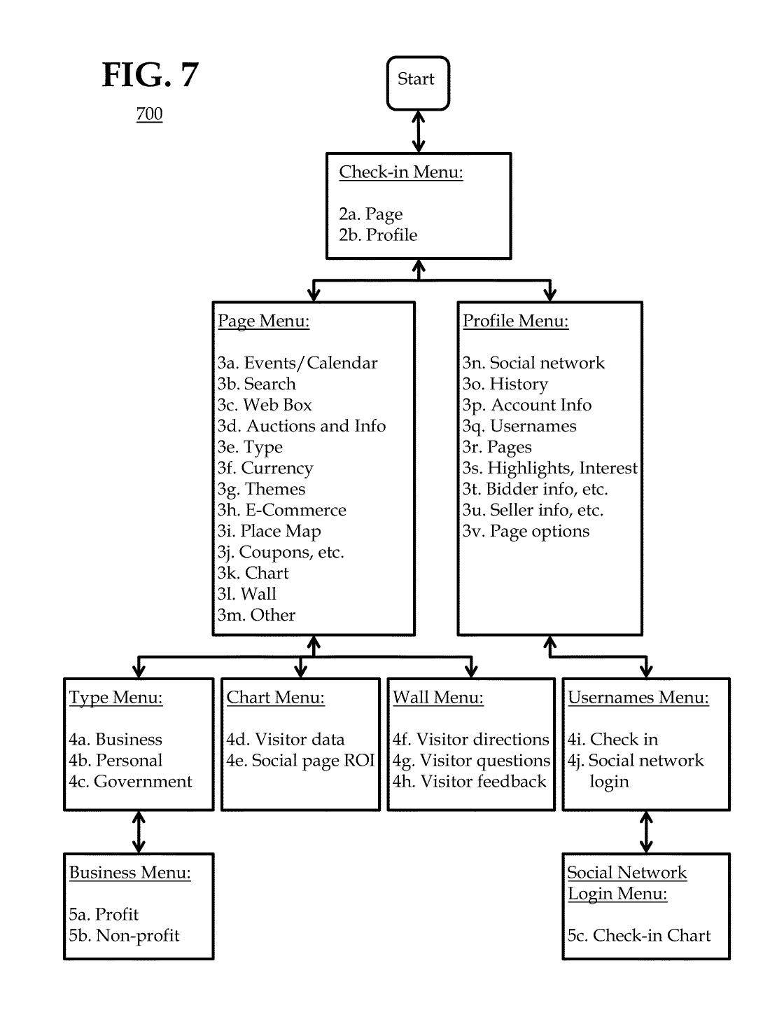

FIG. 7 illustrates a hierarchical menu tree 700 of a user interface in accordance with an embodiment of the present invention.

Embodiments in accordance with the present invention provide a centralized, streamlined, fast, efficient, and effective system and process to provide highly relevant geographical location information, products, and services to visitors through a geographical location-based web presence.

Embodiments in accordance with the present invention include a control method that enables a geographical location's owners and/or its visitors to create and manage a representative and/or facilitative web presence for one or multiple geographical locations. The web presence may be accessible by users within a predetermined radius from those locations. Embodiments provide access to geographic-based or location-based web presence, in which it is the location of the user, rather than the location of the business providing the information, that determines the content. Embodiments may be usable whether or not the user has established an account in accordance with an embodiment of the present invention. The presence may be provided to anonymous users, based upon the user's location.

Embodiments in accordance with the present invention provide an improvement over background art at least in part because embodiments provide for a geographical location's owners, assigned administrators, and/or visitors to create and manage a representative and/or facilitative web presence for one or multiple geographical locations. A representative web presence in this context may refer to a web presence that helps represent the geographic location or its owner and the different web experiences a web visitor may have at the location or for nearby attractions (e.g., a visitor center or help desk directed to help sell items that the store is selling). A facilitative web presence in this context may refer to a web presence that helps a web user locate items or information, i.e., the web presence includes features that facilities what a web user wishes to accomplish by visiting the web presence.

In contrast, the known art does not provide an easy, centralized, effective, and efficient way for location owners or visitors to create or associate such a presence.

Embodiments in accordance with the present invention may allow users to access geographical location-based web presences anonymously, without requiring such users to register in advance or to establish an account.

Embodiments in accordance with the present invention combine information about geographical locations of users, visitors, potential customers and the like, with a customizable World Wide Web-based presence (i.e., “web site”). Customization may be based at least in part upon the geographic locations, locations of businesses, and/or a relationship between the about geographical locations of visitors, etc. to that of the businesses. Embodiments enable providing a novel web site that is capable of delivering a highly relevant source of information and services to people who are visiting various geographical locations. Such persons may consume, through their mobile or handheld computing device, web-based information and services that are relevant to what the persons are currently physically experiencing.

Without such a system in accordance with an embodiment of the present invention, a user would conventionally have to refer to a bookmark list, or search for the geographical location's corresponding web presence.

Such geographically relevant information and services may be offered by agents or other advocates of the location's owners, and/or persons who visit or frequent those locations. In contrast, sites of the known art (e.g., Yelp, etc.) are limited to the web information and services offered through third party applications whose content and its usage in the web presence are not under the control of the location's owner.

Embodiments in accordance with the present invention provide for a freer exchange of information and services between participating businesses and/or community members. Products and services may be targeted more precisely to customers, and customers may be able to formulate a more precise expectation of goods, services, etc. that are available at or near a particular geographic location. Embodiments allow for a new marketplace to develop—a marketplace similar to that provided by the Internet, yet also similar to a real world location and an open community (e.g., crowd-sourcing), enabling an opportunity to seek greater financial profit.

In contrast, the known art does not provide a centralized, streamlined, rapid, efficient, and effective system to provide geographical location visitors with a relatively large source of highly relevant, unique, sharable information.

Furthermore, social networking web sites as currently known in the background art do not work well as a platform for critical user engagement, i.e., user engagement that is likely to lead to sales or increased sales. Embodiments in accordance with the present invention provide critical user engagement during the user's visit to a location where he or she is most likely to have questions or comments directly related to an imminent purchase or recent experience.

Conventional systems of the background art are limited in effectively and efficiently servicing a new kind of marketplace that combines the real world and a web presence, and that can provide competition to provide improved consumer products and services.

Embodiments in accordance with the present invention provide an option for open access (e.g., anonymous access) to the described geographical location-based web presence content, thereby allowing such content to be created by substantially anyone, subject to location verification and user anti-spam qualification algorithms.

Embodiments in accordance with the present invention also enable a legitimate location owner or representative to claim and manage some or all of a community-generated presence, providing improved transparency and accuracy in location-related content. This is specific to chosen invention implementation.

Embodiments in accordance with the present invention enable geographical location-based information, products, and services to be created by both location owners and non-owners of the location. Owners that create or claim geographical location-based web information, products and services may or may not be able to assume control over what web page information, products, and services the community created for the geographical location. For example, location owners may set up a forum for what others (i.e., “the community”) post as “web page information, products, and services,” and the location owner then is not able to change the information. In other embodiments, a moderator function may be provided, such that the location owner may remove spam and other irrelevant information.

Embodiments in accordance with the present invention make use of crowd sourcing, in that if sufficient numbers of users visit and provide feedback or comment on earlier feedback from others, the accuracy of the accumulated feedback will tend to increase, or tend to provide alternate points of view across a wider spectrum of opinions and feedback.

Embodiments provide a capability for an administrator (e.g., a presence administrator) to provide a list of locations for rapid presence syndication (i.e., propagation or cloning) and context or “instance” assignment (i.e., assigning locations to the clones or “instances”). Embodiments in accordance with the present invention provide that the administrator and/or administrator functions may be provided by a processor coupled to a memory, such that the memory stores instructions and data used by the processor to provide administrator functions. A process of assigning web presences with shared foundations to multiple geographical locations, but with customizable contexts and/or instances, enables the provision of geographical location-based web presence and the provision of related maintenance and data management, without affecting the shared foundations of the web presence used at other locations. Shared foundations in this context may refer to objects or descriptions that are common to, or shared among, multiple locations. Locations will then have an “instance” of the foundation, which will be customized to the individual location. This process provides relatively efficient maintenance of presence, and is facilitated because changes to a specific web presence “instance” are constrained to specific locations.

By combining or linking one or more related physical locations with a digital web location in such a way that harnesses the benefits of each location, the embodiments of the invention provide an infrastructure for a unique, more effective and efficient modern marketplace for consumers and businesses to exchange information, goods, and services.

Embodiments in accordance with the present invention facilitate creation of customized digital content by registered or non-registered users of embodiments of the invention and relative new competing third party entities that may provide such services, i.e., the framework for allowing others to provide digital content, and/or the providing itself of the digital content.

Embodiments in accordance with the present invention produce web presence “instances.” A web presence instance may be understood to be a clone of a foundational web presence. The web presence instance may include relative content (i.e., content relative to both the location and/or the world wide foundational content) that may or may not share the same database or database elements, such that the sharing may be based upon whether or not the data and its corresponding component are a part of the foundational presence. The database or its elements may include dynamic data to fill in changing variables within each web presence and the foundational web presence itself. A web presence instance itself may be used as a foundational web presence to provide a substantially similar web presence at child locations, such that the web presence and its content may be modified later without otherwise affecting the web presence or other generated web presence instances available at other geographical locations. A web presence instance may also be available at a single or multiple locations and functions substantially the same as a “web presence.” Therefore, the term “web presence instance” may be used interchangeably throughout when referring to a “web presence.”

Embodiments in accordance with the present invention may include a multi-tier client/server networking architecture with multiple clients and multiple servers communicating with one another through an open network connection. The client computing devices preferably are GPS-enabled.

Optionally, embodiments in accordance with the present invention may provide real-time network communication ability for real-time products and services.

Optionally, to improve usage of embodiments of the invention and/or to integrate embodiments more efficiently and effectively with existing web and/or geographical location-based web presence content, embodiments in accordance with the present invention may further include an informational element that may be added, in order to facilitate search of existing web presences for specific hosted information. The information may indicate coordinates for one or more geographical locations for which the web presence (or a specific portion of the presence) should be associated and recorded for storage within the invention. Embodiments may store web presence and/or the association. If there is no presence and an anonymous user identifies a current website then just the association to the world-wide website domain address may be stored and served as the web presence. But otherwise the web presence is stored separately from other web presences. In some embodiments, access to these web presences from anywhere other than the location for which they are relevant, may involve administrator-level privileges (e.g., privileges to make changes, create new presences, manage existing presences, etc.).

The element to be added may refer to a component or feature that would make information available to search engines based on proximity. Otherwise the information may not be available because it would be irrelevant to a location-based website—for example, pizzerias in New York ordinarily would be irrelevant to a search conducted in China unless the search is not limited only to local discovery. The element may be making public only certain information of the presence, because otherwise it is unnecessary to travel to the location to discover that information. An underlying premise is that, as with traditional websites, users will return to sites whose content frequently changes.

In other embodiments in accordance with the present invention, the geographical location-based web presence itself contains searchable access information indicating whether the presence is a global or world wide web presence, or whether it is a geographical location-based web presence. If the web presence uses geographical location, a list of a single or multiple geographical location coordinates and/or corresponding radius information for which the presence is intended.

In other elements in accordance with an embodiment of the present invention, an element may be added that enables a user to add an existing website for visitor association with a location.

Optionally, some embodiments may include a server to specialize in geographic calculations, i.e., to determine locations and calculate distances between, e.g., a user and a location associated with a web presence.

Optionally, some embodiments of using the invention may include a step of providing visitor requests to location owners, and/or providing owner requests to visitors, in order to attend to permission to make presence content items available within an owner-managed presence and/or a visitor-managed presence, respectively.

Optionally, some embodiments of the invention may be provided as a centralized system, i.e., a platform that is open to additions by third-party developers. Some embodiments may be provided as separate modules, subsystems, or the like, for use among separate systems that may provide automatic or manual incorporation with one or more internal geographical location presence listing systems. Some embodiments may be provided as an external, centralized geographical presence list system or multiple systems. Various embodiments allow for competition among separate market entities that have been granted access to provide the invention or invention components, in order to encourage delivery of improved information and service to users.

For example, an organization using embodiments of the invention may create and provide a custom component or module to adapt an organization's existing web content management system to individual presence generation and/or presence content generation. System management may then integrate with an external presence list and/or presence instance list system.

Alternatively, a system internal to the organization, used to provide remote access to clients, may be given the client's geographical coordinates and/or a user's login credentials, and then used to provide presence information to the user. The system may also be used to find the customer, and/or enabling short-range communication (e.g., NFC) if the customer is lost and/or in need of in-person assistance and communication. This can take place whether or not a user is logged in.

Embodiments in accordance with the present invention provide a customizable web presence for an entity located at one or more geographical locations. The web presence may be quickly created, applied, managed, modified, and accessed. Furthermore, embodiments of the invention may use optional components for presence generation and network communication with a system server. Embodiments of the invention may produce customizable digital content from registered users, and from digital content supplied by third-party information providers. Embodiments of the invention may employ a geographical location-based template system that is centralized and that may or may not be customized to a type or category of a geographic location, or other predetermined factors that facilitate streamlining, i.e., making it easier to rapidly replicate and deploy for different instances/locations of content.

Embodiments of the present invention include a system having one or more processing units coupled to one or more memories. The one or more memories may be configured to store software that, when executed by the one or more processing unit, allows realization of embodiments in accordance with the present invention, at least by use of processes described herein, including at least in FIGS. 2-7, and related text.

### Exemplary Embodiment

An exemplary embodiment may be described with respect to a system to provide location-based social page service, by use of presence, content, template, and other components (generically, “check-in page” components). The embodiment may include a “check-in store,” at which store items are managed by page owners. Page owners are entities that claim a new or existing “check-in location” from a mobile social network (e.g., Foursquare) that has a location database and provides verification for manual inspection to authenticate the location as real and as their own location.

In the present context, a check-in-store may be a check-in-location with an added capability of allowing a user to pay for transactions at a physical location by use of an ecommerce account (e.g., PayPal). A check-in store may combine an ecommerce online store with a physical location store. A user may physically visit a physical store and buy physical items. If the user has an online ecommerce account used to pay for transactions at one merchant, the user can use that same ecommerce account at another merchant conveniently with sharing of billing and/or payment information.

New page owners (i.e., location owners) can then pay for services and manage crowd-sourced digital media for approval and store consignment. A user may receive a share of sales if he or she created the media for sale (e.g., 49% of gross revenue); the store's owner keeps most of the remainder (e.g., in this example 49%), and the ChecklnPage system collects the remainder of the gross revenue as a commission (e.g., in this example 2%). More generally, the cost of commissions may be split among the media creator and the store owner (e.g., equally, or all to one party, etc.) for other commission rates. The store may also opt not to give a percentage at all to crowd-sourced media at the disadvantage of losing incentive for new media generation or revenue generation outside the marketing department. For example, a restaurant diner who highly enjoys a, appetizer, meal, etc., may be willing to buy the recipe if it were offered. In this sense, embodiments offer a bridge between the real world and conventional internet commerce.

The embodiments may further include a “check-in wall,” at which wall posts may be entered and/or viewed. The check-in wall may operate autonomously, in that posts may be generated automatically (e.g., that a particular person was at the restaurant) upon the user checking in at the restaurant, unless the user has their check-in profile set to “private.” The check-in wall may provide public or private feedback on a customer's experience at the geographical location or may publicize suggestions the customer may have for the geographical location. In some embodiments, the check-in wall may provide communication from the location owner back to visitors, e.g., usage tips. In other embodiments, a user may visit the check in wall, and the check in wall may shows the user coupons or daily specials posted for the day from that store's automated presence administrator.

The embodiments may further include photos. In contrast to photos posted by users on a social networking web site, embodiments in accordance with the present invention may post only photos specific to the geographic location, which were taken by various users.

The embodiments may further include an ability to purchase merchandise specific to the geographic location or the owner of a web presence located therein. For instance, users may have an opportunity to buy post cards, T-shirts, hats, signs, mugs, coffee cups, souvenirs, bottled sauces, take-home meals, etc., which may or may not be customized to the owner of the web presence at the geographic location.

The embodiments may further include information related to the geographic location or the owner of a web presence therein. For example, suppose that a local pizzeria franchisee was no longer honoring a discount coupon offered by a nationwide franchisor. If a potential customer unknowingly tries to use the coupon at the local, nonparticipating franchisee and is refused, the franchisee may not only lose a sale but may have also engendered ill will with the potential customer. Embodiments in accordance with the present invention may reduce the likelihood of this scenario occurring by allowing an owner of a geographic location to provide digital information (e.g., a web site) and a commercial transaction capability (e.g., e-commerce on the web site) that have been customized for local conditions relevant to the geographic location or its owner. For example, the local, nonparticipating franchisee may have a customized web site (or a customized page on a social networking site) that provides notices that certain discount coupons are not honored, and the e-commerce platform used at the web site or page would be programmed not to recognize or accept a coupon code corresponding to the non-honored discount coupon.

For example, the information related to the geographic location may include an information section that further includes: (1) Franchise information such as name, contact information, website address in order to direct users to an interactive marketing site, etc., and so forth; (2) Social page information such as lists of existing social page assets and their links; and (3) Brand storytelling that relates a story that may be intended to promote a particular marketing position of the brand.

The embodiments may further include a customized geographical location-based web page section. Such a web page section may be similar to a customized social web page, but may further include content such as regional brochures, location-based contests, location-based e-commerce products and services, and the like. Some customized products may be offered for direct sale to consumers through the web page, such as digital products or tangible (i.e., physical) products. Such web-based direct sales reduce reliance on (or provide an alternative forum to) on-site stores, advertisement, paid agents or spokesmen, etc. Multimedia products that promote the brand or the location, such as audio/video/podcasts, may be offered through the web page.

For example, if the owner of the geographic location is a restaurant, a listing of menu specials for that specific day would be a typical custom item for the web page, and one that embodiments in accordance with the present invention may offer as a template for the customized mobile page.

The embodiments may further include a credit system or loyalty reward program. Such a capability may be similar to digital currency (i.e., credit) system used by some social web page, but may more accurately track loyalty by use of point-of-purchase sales information.

The embodiments may further include a profile interest board. The board may include a chat or discussion capability that is specific to the geographic location or its owner. Board participants may include customers, potential customers, the location owner, etc.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A method to provide customizable web content, comprising:
receiving an access request from a user for a predetermined entity;
receiving an identity of a geographic location of the user;
selecting a web presence for the entity, wherein the web presence corresponds to the geographic location of the user;
customizing the web presence to produce a customized web content; and
providing the customized web content to the user.

2. The method of claim 1, further comprising:
identifying a plurality of web presences for the entity, wherein the plurality of web presences correspond to the geographic locations of the entity;
providing an identity of the plurality of web presences to the user; and
receiving a selection by the user.

3. The method of claim 1, wherein the customized web content is customized for the geographic location of the user.

4. The method of claim 1, wherein the customized web content is customized for a predetermined geographic location provided by the user.

5. The method of claim 1, wherein the customized web content is customized for a distance between the geographic location of the user and a geographic location of the predetermined entity.

6. The method of claim 1, further comprising:
if a predetermined web presence that corresponds to the geographic location of the user does not exist for the entity, creating an association of the predetermined web presence to the geographic location.

7. The method of claim 1, further comprising the step of acquiring login credentials of the user.

8. The method of claim 1, further comprising the step of querying whether the user has a history of producing spam.

9. The method of claim 1, further comprising the step of querying whether the user is a valid API user.

10. The method of claim 1, further comprising the step of querying whether the user has sufficient privilege to customize the web presence.

11. The method of claim 1, further comprising the step of receiving a request from the user to edit a presence instance.

12. The method of claim 11, further comprising the step of checking the request for malicious content.

13. The method of claim 1, further comprising the step of interacting with a second user within a predetermined distance from the geographic location of the user.

14. The method of claim 1, further comprising the step of generating a default web presence for the entity by use of the geographic location of the user.

15. The method of claim 1, wherein the web presence for the entity comprises one instance of a location-based hierarchy of web presences.

16. The method of claim 15, wherein a predetermined portion of the hierarchy of web presences is configured to be updateable as a group.

17. A system to provide customizable web content, comprising:
a web server;
a presence server that is communicatively coupled to the web server;
a user interface module configured to receive an access request from a user for a predetermined entity;
a position-determination module configured to receive an identity of a geographic location of the user; and
a processor coupled to a memory, wherein the processor is configured to perform the steps of:
communicating the geographic location to the presence server;
receiving a web presence from the presence server for the entity, wherein the web presence corresponds to the geographic location of the entity; and
customizing the web presence to produce a customized web content,
wherein the web server is configured to provide the customized web content to the user.

18. The system of claim 17, wherein the customized web content is customized for the geographic location of the user.

19. The system of claim 17, further comprising: a module configured to interact with a second user within a predetermined distance from the geographic location of the user.

20. The system of claim 17, wherein the web presence for the entity comprises one instance of a location-based hierarchy of web presences.
